(19) United States
(12) Patent Application Publication
(10) Pub. No.: US 2014/0253299 A1
(43) Pub. Date: Sep. 11, 2014

(54) CONTROLLING SYSTEM WHICH CONTROLS GAS APPLIANCE VIA REMOTE CONTROL AND THE GAS APPLIANCE OF THE CONTROLLING SYSTEM

(71) Applicant: GRAND MATE CO., LTD., Taichung (TW)

(72) Inventors: CHUNG-CHIN HUANG, Taichung (TW); CHIN-YING HUANG, Taichung (TW); HSIN-MING HUANG, Taichung (TW); HSING-HSIUNG HUANG, Taichung (TW); KUAN-CHOU LIN, Taichung (TW); YEN-JEN YEH, YUNLIN (TW)

(73) Assignee: GRAND MATE CO., LTD., Taichung (TW)

(21) Appl. No.: 13/895,168

(22) Filed: May 15, 2013

(30) Foreign Application Priority Data
Mar. 8, 2013 (TW) 102108331

(51) Int. Cl. G08C 17/02

(52) U.S. Cl. CPC G08C 17/02
USPC 340/12.5

(57) ABSTRACT

A plug member of a gas valve includes a main body. The main body has an axial bore in an axial direction, a first inlet and a second inlet in radial directions, and a guiding slot on a surface. The first inlet and the second inlet are connected to the axial bore. A diameter of the first inlet is greater than a diameter of the second inlet. The guiding slot has a first end communicated with the first inlet and a second end communicated with the second inlet, and a width of the guiding slot gradually reduces from the first end to the second end. Therefore, the gas valve may provide a gas flow with a linear change by controlling the plug member.

The current application claims a foreign priority to the patent application of Taiwan No. 102108331 filed on Mar. 8, 2013.

### BACKGROUND OF THE INVENTION

1. Technical Field

The present invention relates to a gas appliance, and more particularly to a controlling system, which transmits commands to a gas appliance through Wi-Fi.

2. Description of Related Art

Gas appliances, such as gas stove, fireplace, and water heater, are very common in an ordinary house. Typically, the conventional gas appliance has a control panel for manipulative by user to control the gas appliance. However, the conventional control panel is mounted on the gas appliance or near the gas appliance so that user has to walk to the control panel to operate it.

An improved gas appliance is controlled via remote control. Such gas appliance is provided with a transceiver to transmit or receive RF (radio frequency) signals. Therefore, user may control the gas appliance by operating a remote control.

Of course, it needs a specific remote control in communication with the RF transceiver in the gas appliance, and that is an inconvenient part in such gas appliance. If we can fix this drawback, it will give the gas appliance a best control way.

### BRIEF SUMMARY OF THE INVENTION

In view of the above, the primary objective of the present invention is to provide a controlling system, which provides a remote control of a gas appliance through Wi-Fi.

The present invention provides a controlling system of a gas appliance, including a combustor for burning gas, a gas valve for supplying the combustor with a gas flow, a remote control device, a converter, and a controller. The remote control device generates and transmitting Wi-Fi command signals to the converter. The converter has a Wi-Fi transceiver, a converting circuit, and a first RF transceiver. The Wi-Fi transceiver and the first RF transceiver are connected to the converting circuit respectively. The Wi-Fi transceiver receives the Wi-Fi command signal from the remote control device. The converting circuit converts the Wi-Fi command signal into a RF command signal. The first RF transceiver sends the RF command signal out. The controller has a second RF transceiver and a controlling circuit. The controlling circuit is connected to the second RF transceiver and the gas valve respectively. The second RF transceiver receives the RF command signal from the first RF transceiver and transmits the RF command signal to the controlling circuit. The controlling circuit controls the gas valve to adjust the gas flow according to the command in the RF command signal.

A gas appliance, which receives a Wi-Fi command signal from a remote control device, includes a combustor for burning gas, a gas valve for supplying the combustor with a gas flow, a converter, and a controller. The converter has a Wi-Fi transceiver, a converting circuit, and a first RF transceiver. The Wi-Fi transceiver and the first RF transceiver are connected to the converting circuit respectively. The Wi-Fi transceiver receives the Wi-Fi command signal from the remote control device. The converting circuit converts the Wi-Fi command signal into a RF command signal. The first RF transceiver sends the RF command signal out. The controller has a second RF transceiver and a controlling circuit. The controlling circuit is connected to the second RF transceiver and the gas valve respectively. The second RF transceiver receives the RF command signal from the first RF transceiver and transmits the RF command signal to the controlling circuit. The controlling circuit controls the gas valve to adjust the gas flow according to the command in the RF command signal.

With the controlling system of the present invention, any electronic device, which is able to transmit and receive Wi-Fi signal, may be used as a remote control of the gas appliance. It is very convenient for the people who have mobile devices, such as smart phone and tablet to control the gas appliance at home from a distance.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a sketch diagram of a first preferred embodiment of the present invention;

FIG. 2 is a sketch diagram of a second preferred embodiment of the present invention;

FIG. 3 is another sketch diagram of the second preferred embodiment of the present invention;

FIG. 4 is a sketch diagram of a third preferred embodiment of the present invention.

### DETAILED DESCRIPTION OF THE INVENTION

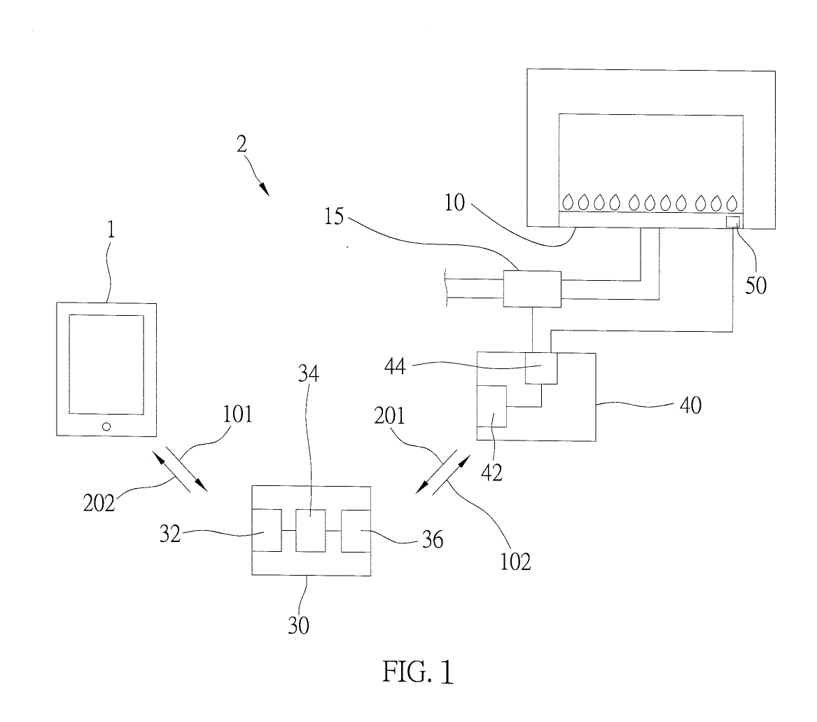

FIG. 1 shows a sketch diagram of a controlling system the first preferred embodiment of the present invention, which includes a remote control device 1 and a gas appliance 2. In an embodiment, the remote control device 1 is a smart phone, which is installed with an application for user to inputs commands, and then generates Wi-Fi command signals 101 accordingly. The Wi-Fi command signals 101 are sent to the gas appliance 2. The gas appliance 2 is a fireplace, including a combustor 10, a gas valve 15, a converter 30, a controller 40, and a sensor 50.

The combustor 10 is a conventional device to burn gas and generate flames.

The gas valve 15 is mounted on a gas pipe, which supplies the combustor 10 with gas, to adjust a gas flow in the gas pipe. In an embodiment, the gas valve 15 is a ratio valve, which is controllable via electric signals. Of course, the gas valve 15 could be any type of valve to adjust the gas flow.

The convertor 30 has a Wi-Fi transceiver 32, a converting circuit 34, and a first RF (radio frequency) transceiver 36, wherein the Wi-Fi transceiver 32 and the first RF transceiver 36 are connected to the converting circuit 34 respectively. The Wi-Fi transceiver 32 is in communication with the remote control device 1 through Wi-Fi Direct. The Wi-Fi transceiver 32 receives the Wi-Fi command signal 101 from the remote control device 1, and then the converting circuit 34 converts the Wi-Fi command signal 101 into a RF command signal 102. Next, the RF command signal is sent out through the first RF transceiver 36t.

The controller 40 is beside the gas valve 15, or is mounted on the gas valve 15 directly. The controller 40 has a second RF transceiver 42 and a controlling circuit 44, wherein the controlling circuit 44 is connected to the second RF transceiver 42 and the gas valve 15 respectively. The second RF transceiver 42 receives the RF command signal 102 from the convertor 30, and sends it to the controlling circuit 44. The controlling circuit 44 reads the RF command signal 102 to obtain the command therein, and controls the gas valve 15 according to the command.

As a result, except for the conventional RF remote control, any device, which transmits and receives Wi-Fi signals, and is installed with the application, may be used as a remote control of the gas appliance.

The sensor 50 is provided beside the combustor 10 to sense a temperature of the combustor 10, and send it to the controlling circuit 44. The controlling circuit 44 generates a RF status signal 201, which includes the information of the temperature sensed by the sensor 50 and the condition of the gas valve 15, and sends it to the first RF transceiver 36 through the second RF transceiver 42. Next, the converting circuit 34 receives the status signal 201 from the first RF transceiver 36, and converts it into a Wi-Fi status signal 202. The Wi-Fi status signal 202 is transmitted to the remote control device 1 through the Wi-Fi transceiver 32 to show the status information of the gas appliance 2 on the remote control device 1. Therefore, the user may monitor the gas appliance 2 by the remote control device 1.

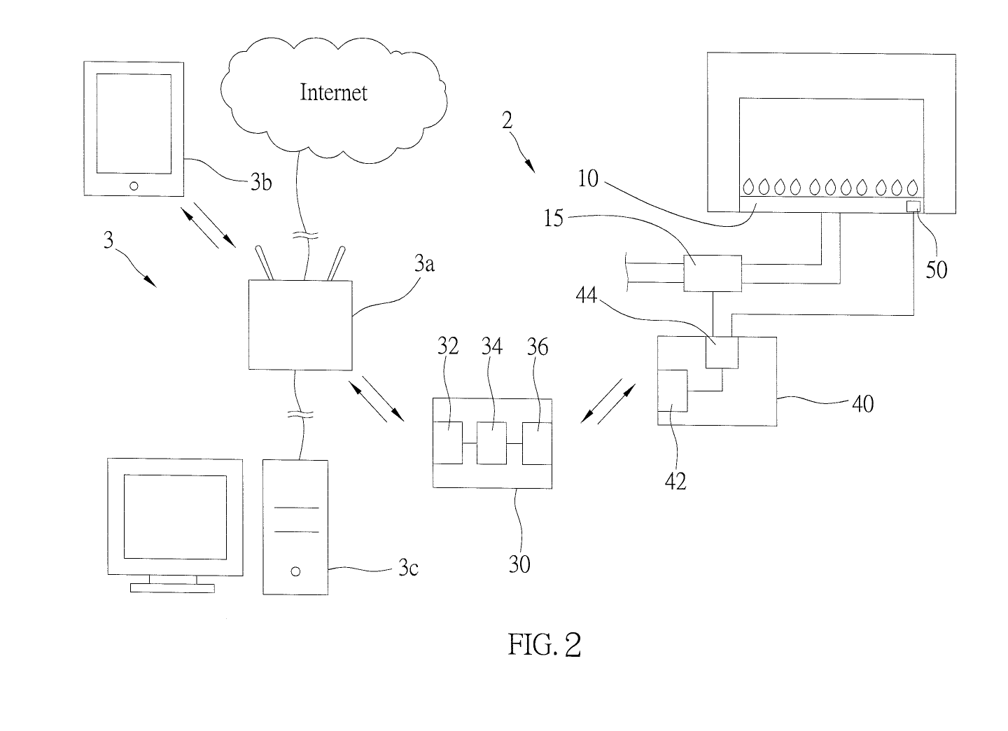

FIG. 2 shows a controlling system of the second preferred embodiment of the present invention, which is similar to the first preferred embodiment, except that a remote control device 3 includes a wireless access point (AP) 3a and a smart phone 3b. The wireless AP 3a is connected to internet, and the smart phone 3b is connected to the wireless AP 3a through Wi-Fi. The smart phone 3b generates a Wi-Fi command signal according to the command input by the user, and sends it to the wireless AP 3a, and then the Wi-Fi command signal is transmitted to the converter 30 for the same procedures as above. On the contrary, the wireless AP 3a receives the Wi-Fi status signal from the converter 30, and sends it to the smart phone 3b to allow the user to monitor the gas appliance 1 on the smart phone 3b.

The wireless AP 3a works like a repeater in the controlling system of the present invention. However, the smart phone 3b may connect to internet through the wireless AP 3a at the same time. In other words, the controlling system of the present invention does not interfere with the normal function of the smart phone 3b.

The remote control device 3 of the second preferred embodiment further has a computation device 3c, such as desktop and laptop. The computation device 3c is connected to the wireless AP 3a through RJ-45 interface. Therefore, the computation device 3c will has the same function as the smart phone 3b if it is installed with the application.

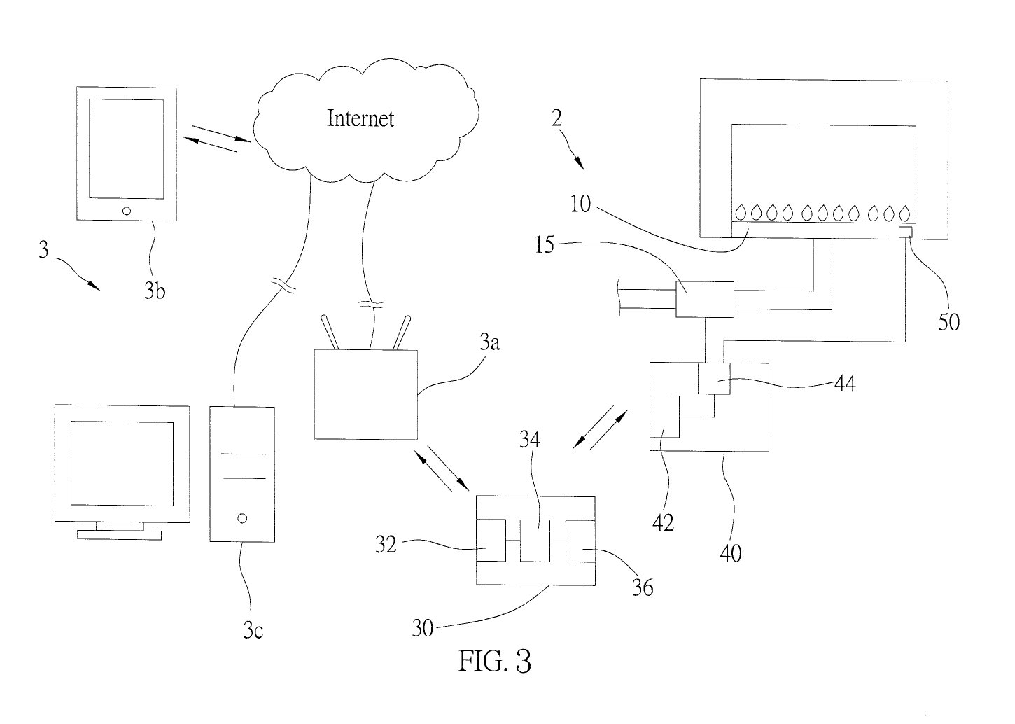

FIG. 3 shows another controlling system, in which the smart phone 3b and/or the computation device 3c are connected to the wireless AP 3a through internet. A signal, which includes the command inputted by the user, is transmitted to the wireless AP 3a from the smart phone 3b or the computation device 3c through internet, and then the wireless AP 3a converts the signal into a Wi-Fi command signal, and then transmits it to the converter 30. All functions of this embodiment are the same as above.

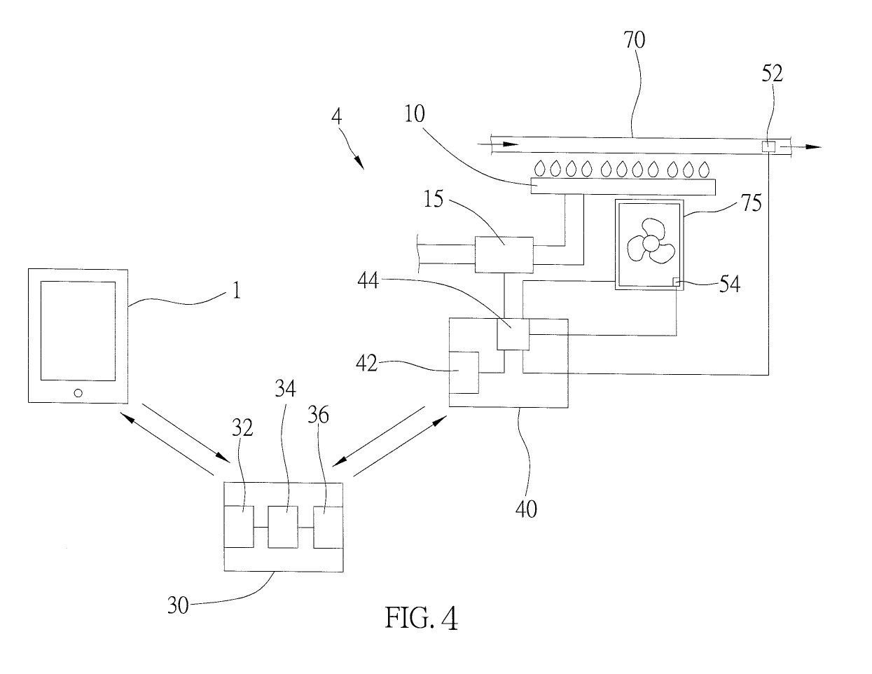

FIG. 4 shows a controlling system of the second preferred embodiment of the present invention. A gas appliance 4 here is a water heater, including a combustor 10, a gas valve 15, a converter 30, and a controller 40, which are the same as the first preferred embodiment. The gas appliance 4 further has a water pipe 70 and a fan 75. The combustor 10 heats water in the water pipe 70. The fan 75 supplies the combustor 10 with an air flow for burning gas.

The functions of the controlling system of the second preferred embodiment are the same as above. User may control the gas valve 15 and the fan 70 of the gas appliance 4 through the remote control device 1. The control way is the same as above.

The controlling system of the second preferred embodiment includes two sensors 52, 54. The sensor 52 senses a temperature of the water out of the water pipe 70, and the sensor 54 senses a speed of the fan 75, so that the status signal may further include the speed of the fan 75 and the water temperature.

It is noted that the water heater may incorporated in the systems shown in FIG. 2 and FIG. 3 as well. It must be pointed out that the embodiments described above are only some preferred embodiments of the present invention. All equivalent methods which employ the concepts disclosed in this specification and the appended claims should fall within the scope of the present invention.

What is claimed is:

1. A controlling system of a gas appliance, comprising:
a combustor for burning gas;
a gas valve for supplying the combustor with a gas flow, wherein the gas valve is controllable to adjust the gas flow;
a remote control device for transmitting Wi-Fi command signals, wherein the Wi-Fi command signal includes a command;
a converter having a Wi-Fi transceiver, a converting circuit, and a first RF transceiver, wherein the Wi-Fi transceiver and the first RF transceiver are connected to the converting circuit respectively; the Wi-Fi transceiver receives the Wi-Fi command signal from the remote control device; the converting circuit converts the Wi-Fi command signal into a RF command signal; and the first RF transceiver sends the RF command signal out; and
a controller having a second RF transceiver and a controlling circuit, wherein the controlling circuit is connected to the second RF transceiver and the gas valve respectively; the second RF transceiver receives the RF command signal from the first RF transceiver and transmits the RF command signal to the controlling circuit; and the controlling circuit controls the gas valve to adjust the gas flow according to the command in the RF command signal.

2. The controlling system of claim 1, wherein the remote control device is communicated with the converter through Wi-Fi Direct.

3. The controlling system of claim 1, wherein the remote control device includes an electronic device and a wireless access point; the electronic device is connected to the wireless access point through internet; the electronic device generates a signal including the command, and transmits the signal to the wireless access point; and the wireless access point converts the signal into the Wi-Fi command signal, and transmits the Wi-Fi command signal to the Wi-Fi transceiver of the converter.

4. The controlling system of claim 1, wherein the remote control device includes an electronic device and a wireless access point; the electronic device is connected to the wireless access point; the electronic device generates the Wi-Fi command signal, and transmits the Wi-Fi command signal to the Wi-Fi transceiver of the converter through the wireless access point.

5. The controlling system of claim 1, further comprising a fan for supplying the combustor with an air flow, wherein the controlling circuit is connected to the fan to control the fan according to the command in the RF command signal.

6. The controlling system of claim 5, further comprising a sensor for sensing a speed of the fan, wherein the sensor is connected to the controlling circuit; the controlling circuit generates a RF status signal according to a signal from the sensor, and transmits the RF status signal to the converting circuit of the converter through the second RF transceiver and the first RF transceiver; the converting circuit converts the RF status signal into a Wi-Fi status signal, and then the Wi-Fi status signal is transmitted to the remote control device through the Wi-Fi transceiver.

7. The controlling system of claim 1, further comprising a sensor for sensing a temperature of the combustor, wherein the sensor is connected to the controlling circuit; the controlling circuit generates a RF status signal according to a signal from the sensor, and transmits the RF status signal to the converting circuit of the converter through the second RF transceiver and the first RF transceiver; the converting circuit converts the RF status signal into a Wi-Fi status signal, and then the Wi-Fi status signal is transmitted to the remote control device through the Wi-Fi transceiver.

8. The controlling system of claim 1, further comprising a sensor for sensing a temperature of an object, which is heated by the combustor, wherein the sensor is connected to the controlling circuit; the controlling circuit generates a RF status signal according to a signal from the sensor, and transmits the RF status signal to the converting circuit of the converter through the second RF transceiver and the first RF transceiver; the converting circuit converts the RF status signal into a Wi-Fi status signal, and then the Wi-Fi status signal is transmitted to the remote control device through the Wi-Fi transceiver.

9. The controlling system of claim 1, wherein controlling circuit generates a RF status signal according to a status of the gas valve, and transmits the RF status signal to the converting circuit of the converter through the second RF transceiver and the first RF transceiver; the converting circuit converts the RF status signal into a Wi-Fi status signal, and then the Wi-Fi status signal is transmitted to the remote control device through the Wi-Fi transceiver.

10. A gas appliance, which receives a Wi-Fi command signal from a remote control device, comprising:
a combustor for burning gas;
a gas valve for supplying the combustor with a gas flow, wherein the gas valve is controllable to adjust the gas flow;
a converter having a Wi-Fi transceiver, a converting circuit, and a first RF transceiver, wherein the Wi-Fi transceiver and the first RF transceiver are connected to the converting circuit respectively; the Wi-Fi transceiver receives the Wi-Fi command signal from the remote control device; the converting circuit converts the Wi-Fi command signal into a RF command signal; and the first RF transceiver sends the RF command signal out; and
a controller having a second RF transceiver and a controlling circuit, wherein the controlling circuit is connected to the second RF transceiver and the gas valve respectively; the second RF transceiver receives the RF command signal from the first RF transceiver and transmits the RF command signal to the controlling circuit; and the controlling circuit controls the gas valve to adjust the gas flow according to the RF command signal.

11. The controlling system of claim 10, wherein the remote control device is communicated with the converter through Wi-Fi Direct.
